(19) United States
(12) Patent Application Publication
(10) Pub. No.: US 2012/0180705 A1
(43) Pub. Date: Jul. 19, 2012

(54) TABLE FOR KEEPING FOODS LOCATED IN DISHES WARM AND TABLE COMPRISING ONE OR MORE INDUCTION MODULES

(75) Inventor: Timo Hafner, Radolfzell (DE)

(73) Assignee: Gastros AG, Zurich (CH)

(21) Appl. No.: 13/260,896

(22) PCT Filed: Mar. 31, 2010
(86) PCT No.: PCT/DE2010/000370

§ 371 Date: Mar. 27, 2012

(30) Foreign Application Priority Data
Apr. 3, 2009 (DE) 10 2009 003 743.8

(51) Int. Cl. A47B 31/02; H05B 6/12

(52) U.S. Cl. 108/50.13; 219/621

(57) ABSTRACT

Table for keeping food warm in dishes, said table having a storage surface for the dishes and furthermore having a carrying surface that is provided beneath the storage surface and that is moreover intended for receiving at least one heat source, the storage surface being supported by a continuous table top and the carrying surface being supported by an intermediate shelf, either the table top being configured as fixed and the intermediate shelf opposite the table top being adjustable in height with respect to said table top, or the intermediate shelf being configured as fixed and the table top as being removable.

### FIELD OF THE INVENTION

The invention relates to a table for keeping food warm that is in dishes, said table having a storage surface for the dishes and having a carrying surface, located beneath the storage surface, for receiving at least one heat source. The invention furthermore relates to a table having at least one induction module arranged within the table. “Table” is to be understood as table-like furnishings such as buffets, counters or the like; the term “keeping warm” is intended to comprise the cooking and/or the presenting of food in dishes. Burners that contain fuel paste, for example, can serve as energy sources.

### BACKGROUND OF THE INVENTION

Facilities are already known in the catering industry that keep food warm by means of water baths heated with fossil energy so that the food can be presented and offered as part of a buffet, for example. Conventional electric burner hot plates are known from the food preparation sector, are arranged, for example, in housings or in stovetops, and are suitable both for heating and cooking owing to their high heat output. Another alternative for keeping food warm at buffets is the so-called infrared emitter. Said infrared emitters serve to heat food from both below and above.

All equipment has the disadvantage, particularly with the handling of burners, that the food must be kept warm in hot water baths since the burners must not come into contact with the dishes on which the food is served. Handling in this set-up is very unwieldy and not very effective. There is often the risk that the food will get overheated. Should one wish to avoid this, one still runs the risk that the food will be only lukewarm.

Nevertheless, DE 101035331 A1 discloses a piece of heat-retaining equipment that is arranged in a fixed manner in a flat surface, such as in a table top. It has a storage surface and at least one electrically heated heat source arranged on a carrying surface beneath the storage surface, the storage surface and the upper surface of the table top substantially being positioned in a common plane. Such a piece of heat-retaining equipment is fixed in, that is to say constructed integrally with, a dining table top and can furthermore be arranged in multiple positions depending on the respective seating arrangement of individuals at the table.

A considerable disadvantage of the prior art is that heat can be lost during the transfer of heat from the heat source to the corresponding dishes that are holding food. Moreover, the ambient temperature can be easily over-heated, resulting in considerable discomfort for the user in both buffet presentation as well as during eating.

The object of the invention is to provide a piece of furniture, particularly for keeping food warm, in which the abovementioned disadvantages are not present and in which a dining table can be installed very easily so that the food can be displayed in a buffet-like manner while it is simultaneously kept warm.

### SUMMARY OF THE INVENTION

With furniture serving as a table, the solution to the problem consists in the storage surface for the dishes holding the food being supported by a continuous table top and the carrying surface for at least one heat source being supported by an intermediate shelf, either the table top being configured as fixed and the intermediate shelf opposite the table top preferably being adjustable in height with respect to said table top, or alternatively the intermediate shelf being configured as fixed and the table top being removable.

A substantial advantage of the invention consists in the fact that a piece of furniture in the form of a table, as with the present invention, can be easily installed and used in its configuration as equipment designed to keep things warm. The table top can, advantageously, be configured so as to swing open like a lid or it can be removable or alternatively translationally or rotationally shiftable, thereby providing easy access to the carrying surface.

Furthermore, it can be a great advantage if a plurality of heat sources are provided on the carrying surface of the intermediate shelf in order to increase the number of warming locations, it being advantageous to position modularly configured hot plates or induction modules on the intermediate shelf in the piece of furniture in such a manner that they are invisible to the observer or to those who, for example, are serving themselves at the buffet or eating at a table. In this way, keeping food warm can occur in a more purposeful manner. The heat sources are preferably simply positioned on the carrying surface.

In theory, the table according to the invention has beneath the one table surface a second level. This second level in the form of the intermediate shelf can be characterized in that it can be somewhat lowered for loading of the individual induction modules and the second level (level on which the induction modules are positioned) is larger, which substantially simplifies the handling of the induction modules. Should the second level be loaded, this second level in the form of an intermediate shelf can be raised in the direction of the first level, however with a certain distance being maintained between the surface of one induction module and the bottom surface of the actual table surface. Maintaining this distance ensures that a certain stray field is present, making it possible for the food to be more effectively kept warm. It has also been shown that even a defined distance from the induction module to the dish results in optimal utilization and coupling of the energy.

It is allowed for by the alternatively provided embodiment, according to which the second level in the form of an intermediate shelf is configured as fixed beneath the first level (of the actual table level), that the table top can be removed in order to have greater ease of access to the respective heat sources. The table top can be configured for this purpose as being able to be swung open, that is to say like a lid, so that the individual induction modules can be placed from above onto the second level. Additional variants can consist in the table top being configured as simply removable or alternatively as translationally or rotationally shiftable in one manner or another.

With the design that is shown, a table is nevertheless provided, in which the individual induction modules can easily be placed on the intermediate shelf, that is to say the induction modules which are customarily difficult to access can be loaded and removed with greater ease.

The table top is preferably composed of calendered glass. This material has the added advantage that it is easy to clean and is furthermore advantageous because the magnetic fields of the induction elements can easily penetrate glass materials in order to interact with the correspondingly designed dishes in such a manner that the food contained in the dishes can be heated up well or kept warm.

It is moreover advantageous if the induction modules are configured in such a manner that the respective induction coils are very clearly displayed on the surface of the induction module, that is to say they can be recognized optically, so that this displayed indication is also visible through the calendered glass. This makes it possible for users who prepare the buffet or place dishes on the table to determine the correct positioning of the dishes.

The induction modules themselves are preferably configured as having a box shape and contain, in addition to the necessary electronics, also the requisite induction coils. Each induction module has at least one induction coil, the size of the induction coil and thus of the “hot plate” being shown on the surface of each respective module. The induction modules themselves are powered electrically and can be operated at different power levels. The induction modules furthermore preferably have plug and socket connections, for example with cables, plugs, and sockets for their power supply. One on-site wall socket is sufficient for supplying power to a plurality of induction modules. The output of the induction module is also preferably individually adjustable for each induction module when power is supplied in a shared fashion.

The table according to the invention preferably has identical induction modules. Thus induction modules that differ in dimension, shape, output, etc are unnecessary. Since the induction modules are positioned on the carrying surface of the table beneath the table top, their quantity and arrangement can vary and be adjusted specifically to the events in question. For large and/or long dishes, two or more induction modules can be positioned on the carrying surface. The invention makes possible the problem-free adjustment of the induction modules and their output to the dimensions, shape, and arrangement of the plates that are on the table top and are to be kept warm.

A display element can be provided on the surface of the induction modules in order to represent the different power levels, by means of which display element the observer can verify the respective power level that has been set. In order to be able change the power levels, a remote control can be provided for the induction modules in addition to the manually operable adjusting element that may be provided. A remote control is advantageous in that the individual induction modules can be operated separately since they are arranged beneath the first level, that is to say the table top, and are thus difficult to access. The remote control can preferably be designed as an indicating instrument. What is meant by this is that the remote control, in particular its housing, is configured in such a manner that user can recognize, preferably intuitively perceive, the direction in which the remote control sends a signal. This is possible through a long-range remote control, for example. This has the added advantage that the user can point to a certain induction module and set one of the pre-determined power levels either by pressing a button or by turning a corresponding dial. Owing to the optical configuration of the display instrument of the induction modules, the user can recognize the respective power levels through the glass table level as well. The display instrument can have light-emitting diodes, for example, to display the power levels. It is not necessary for the user to use an individual remote control for each individual induction module or for the user to change a channel. It is thereby possible to operate each induction module individually with one and the same remote control. It is sufficient merely to point such a remote control device in the direction of the desired induction module so that the transmitted signal reaches only the selected induction module.

The remote control preferably transmits a directed signal, the signal dispersing, diffusing, for example, in a conically-shaped fashion. If the remote control is within reasonably close proximity to the induction module, this will reliably ensure that the module is “hit”. That is to say, the signal of the remote control reaches the receiver section of an induction module and does not reach the receiver section of a neighboring induction module. The display element lets the user know that an induction module has been adjusted or re-adjusted and which induction module has been affected. The remote control can exhibit a short range of approximately 10 cm or several centimeters beyond 10 cm into the meter range of about 1 m to 1.5 m or 2 m. The directive efficiency of the remote control is thereby sufficient to adjust precisely a desired induction module. The remote control preferably transmits an infrared signal that need not be a laser beam since a beam of light is sufficient that is optically focused with lenses and/or mirrors or alternatively that fans out in a conical shape. Visible light can also be used and has the advantage that the induction module that is “hit” can be seen. A beam of light can also be used exclusively for aiming at the desired induction module and the signal can be transmitted from the remote control to the induction module in a different manner. Moreover, it is possible for the remote control to use other signals such as, for example, acoustic, ultrasonic, or electromagnetic signals to adjust the power levels of the induction modules.

In addition to the aforementioned adjusting of a power level, it is also possible to turn the respective induction modules on and off from the external side (from the respective side) of the table.

The induction modules are advantageously measured in their dimensions so that they can be received by the dish furnishings and equipment known and used in the food industry. Long dishes and food containers or platters in particular can be kept warm in such a manner that they overlap at least two induction modules. All induction modules can be configured as having the same dimensions.

A piece of furniture in the form of a table is thus created with which food can be very easily presented and kept warm, while it is also suitable for cooking food with the user neither being disturbed by a high environmental temperature nor having to attend to the cooking module in question, in this instance induction modules, as is customary with burners, for example.

The installation of the induction modules is very simple since they can be inserted into a second level—the intermediate shelf—arranged beneath the actual table top, and said induction modules can furthermore be arranged at a certain distance to the upper surface of the table. It is accordingly not necessary to provide appropriate recesses in the table into which the induction modules must be placed without being afforded any flexibility in terms of arrangement. In contrast, it is possible to arrange the induction modules freely on the second level. Loading the induction modules onto the second level is very easy since different fittings are provided that make it possible to position induction modules easily on these levels. Operating the induction modules can likewise be effected in a simple and intuitive manner since the desired power level of an induction module can be established by merely pointing the possible remote control apparatus at the induction module to be set.

In this manner, the distance between induction module and dish can always be maintained in an optimal operation range.

Additional advantages of the invention can be found in the following description, in the drawings, and in the claims.

### BRIEF DESCRIPTION OF THE DRAWINGS

FIG. 1 shows a perspective view of a table according to the invention;

FIG. 2 shows a perspective view of a table according to FIG. 1 on a smaller scale, however at a time when induction modules are just being inserted into the table;

FIG. 3 shows a view of the table according to FIG. 2 with a plurality of induction modules and

FIG. 4 shows a perspective view of the table according to FIG. 3, while it is being used as a buffet.

### DETAILED DESCRIPTION OF PREFERRED EMBODIMENTS OF THE INVENTION

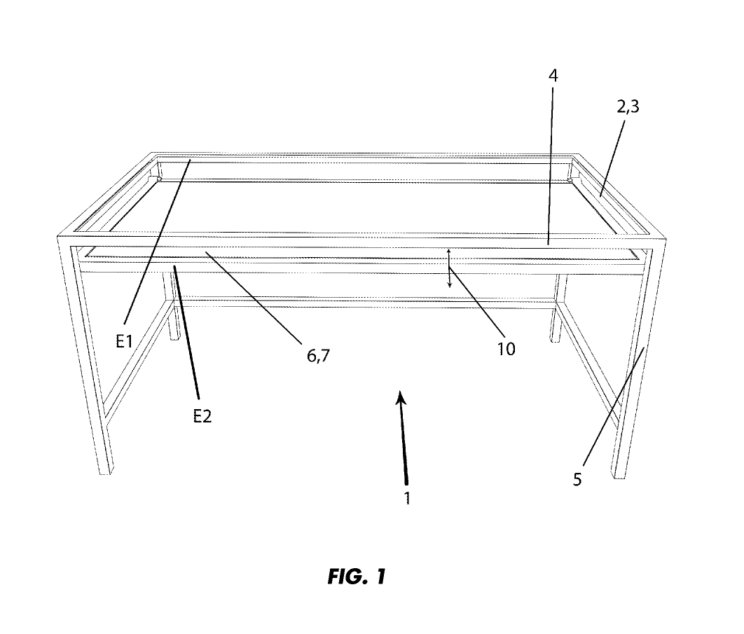

The table, referenced with numeral 1, represented in perspective in FIG. 1, has a storage surface 2 of a table top 3 composed of calendered glass, which storage surface is positioned in a table frame 4. The table frame 4 is supported by four table legs 5 between which a carrying surface 6 in the form of an intermediate shelf 7 is provided beneath the table top 3.

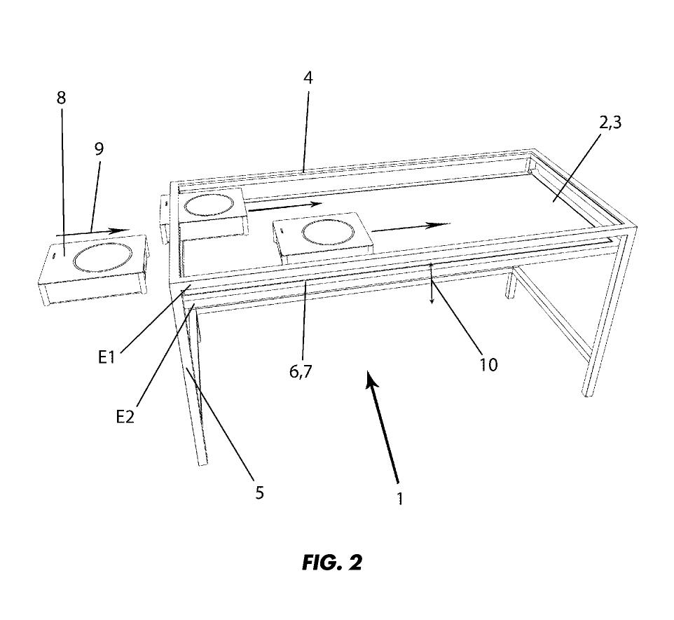

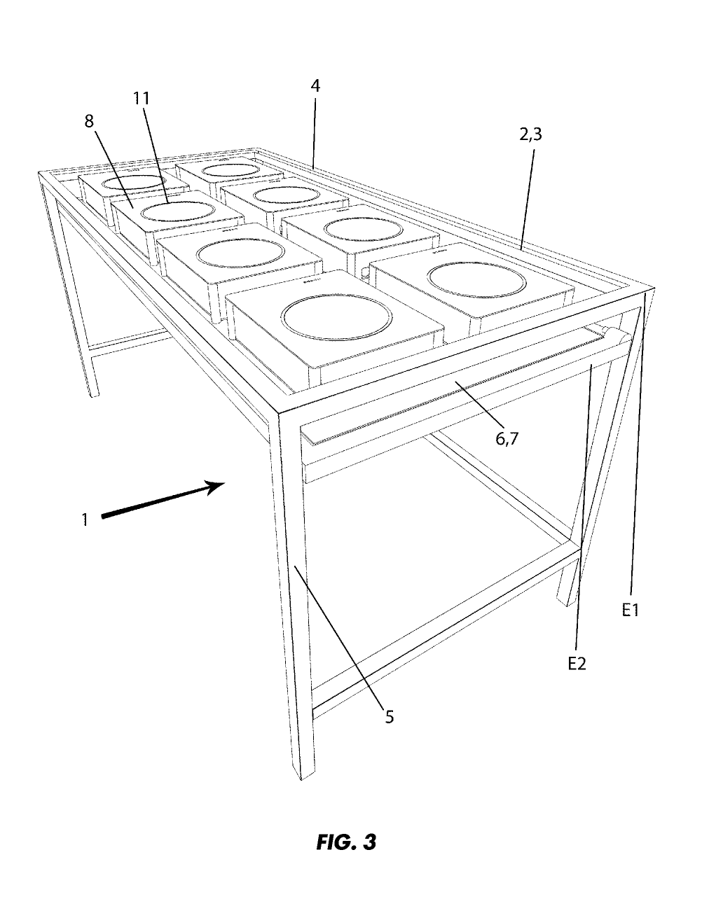

As is shown in FIG. 2, induction modules 8 serving as heat sources are inserted here corresponding to the arrows 9 between the table top 3 as the first level E1 of the table 1 and the intermediate shelf 7 as the second level E2. The second level E2 is configured as height adjustable with respect to the first level E1, which is indicated by arrow 10 in FIG. 1 and FIG. 2, that is to say the clearance between the first level E1 and the second level E2 can be increased. It is thereby possible to easily place the induction modules 8 on the carrying surface 8 of level E2. After placing all induction modules 8 according to FIG. 3, the intermediate shelf 7 of level E2, as represented by arrow 10, is pushed upward until a smaller distance is achieved between the underside of the table top 3 of the level E1 and the surface of the induction modules 8. In order to achieve optimal heating, this distance ought to be maintained.

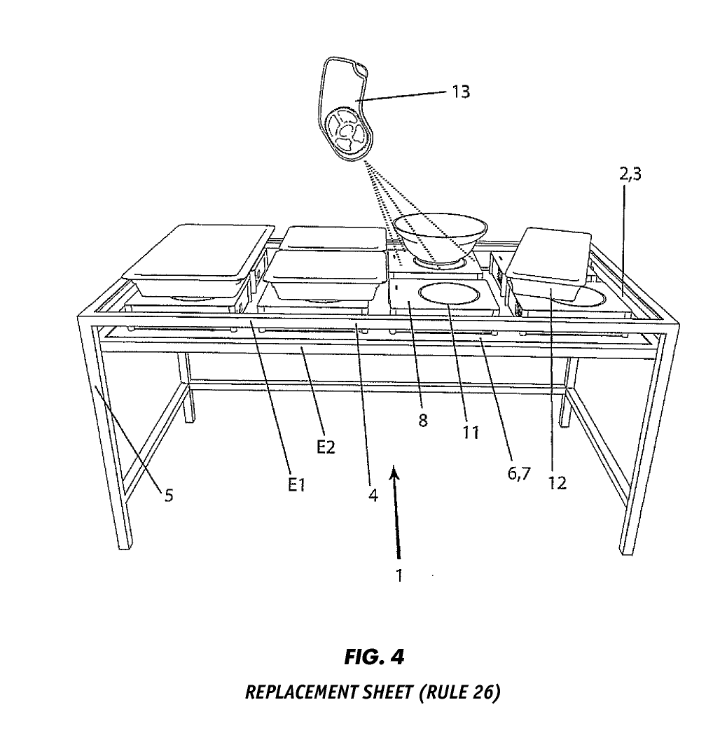

The respective surfaces of the induction modules 8 are represented with a circle 11 that corresponds to the diameter of the coil that is arranged in the induction module 8. The circles 11 are visible through the table top 3 that is composed of glass, preferably designed as frosted, so that dishes 12 in the form of bowls and crocks according to FIG. 4 can be easily positioned.

All induction modules 8 of the table are identical. For power supply purposes, a plurality of induction modules 8 are connected to one another by means of cable plug connections that are not shown. Two on-site wall outlets, for example, are sufficient for supplying power to the induction modules 8 of the table 1. Despite sharing a joint power supply, the power levels of the induction modules 8 can be adjusted independently of one another. The induction modules 8 optically display the set power levels by means of light emitting diodes, for example.

The table 1 has a remote control 13, which is shown as disproportionately large in FIG. 4, for adjusting the power levels of the induction modules 8. The remote control 13 transmits a cone-shaped optical signal in the infrared range, as is indicated in FIG. 4 through dotted lines. A housing of the remote control 13 is configured in such a manner that a user intuitively perceives the direction of the signal and can direct the remote control 13 so that its signal hits one induction module 8 the power level of which is to be adjusted or re-adjusted, without the signal affecting another neighboring induction module 8. It is possible to adjust the power levels of all induction modules 8 with one single remote control apparatus 13 without the remote control 13 having to have different channels or another type of individualization of the induction modules 8. The user can recognize which induction module 8 is being adjusted or re-adjusted on the display elements of the induction modules 8 so that the desired induction module 8 can be adjusted or re-adjusted without effecting the same change in an induction module 8 that is adjacent thereto, for example.

### REFERENCE NUMERAL LIST

1 Table
2 Storage surface
3 Table top
4 Table frame
5 Table leg
6 Carrying surface
7 Intermediate shelf
8 Induction module
9 Arrow (installation)
10 Arrow (height adjustable)
11 Circle
12 Dishes
13 Remote control

1. A table for keeping food warm in dishes that comprises:
a storage surface for the dishes; and
a carrying surface that is located beneath the storage surface and that is adapted for receiving at least one heat source, wherein the storage surface is supported by a continuous table top and the carrying surface is supported by an intermediate shelf wherein either (i) the table top is configured as being fixed with the intermediate shelf opposite the table top being adjustable in height with respect to the table top or (ii) the intermediate shelf is configured as being fixed with the table top being removable.

2. The table according to claim 1 having a removable table top that is configured to be swung open like a lid, to be removed, or to be translationally or rotationally shifted.

3. The table according to claim 1 wherein the table top that serves as the storage surface for the dishes is composed of a calendered glass.

4. The table according to claim 1 wherein the support surface of the intermediate shelf is provided with at least one heat source in the form of a modularly designed hot plate.

5. The table according to claim 1 wherein at least one induction module is provided on the support surface, which induction module generates a magnetic field for heating one of the dishes.

6. The table according claim 5, wherein the at least one induction modules is configured so that the arrangement of the induction coils is optically recognizable.

7. The table according to claim 5 comprising a plurality of induction modules that are identical.

8. The table according to claim 5 wherein the at least one induction module has an electric plug and socket connection.

9. The table according to claim 5 wherein the at least one induction module has a display element that indicates the power level.

10. The table according to claim 5 wherein the at least one induction module has a remote control apparatus for the at least one induction modules.

11. The table according to claim 10 wherein the remote control apparatus exhibits a short range of approximately 10 cm to 2 m.

12. The table according to claim 5 wherein power level of the at least one induction module can be changed manually by adjusting elements provided on the at least one induction modules or by a remote control apparatus.

13. The table according to claim 10 wherein the remote control apparatus is configured as a display element.

14. The table according to claim 5 wherein the power levels of the at least one induction modules is adjustable on the outside of the table.

15. The table according to claim 5 comprising a height-adjustable intermediate shelf wherein the distance from the at least one induction modules to the table top is adjustable in such a manner that a certain stray field of the magnetic coils of the at least one induction modules is present.

16. The table according to claim 1 wherein warm water is not used to heat the dishes.

17. A table for keeping food in containers warm that comprises:
an upper support on which the containers are placed; and
a lower support, that is directly underneath the upper support, onto which one or more heat sources are removably positioned, wherein each heat source is operated by electricity and is not in direct physical contact with the upper support.

18. The table of claim 17 wherein the upper support is made of calendered glass.

19. The table of claim 17 wherein each heat source comprises a modularly designed hot plate.

20. The table of claim 17 wherein each heat source comprises an induction module that generates a magnetic field that heats the containers.
